(19) United States
(12) Patent Application Publication
(10) Pub. No.: US 2010/0169673 A1
(43) Pub. Date: Jul. 1, 2010

(54) Efficient remapping engine utilization

(76) Inventor: Ramakrishna Saripalli, Cornelius, OR (US)

Correspondence Address: INTEL CORPORATION;c/o CPA Global, P.O. BOX 52050, MINNEAPOLIS, MN, 55402, US

(21) Appl. No.: 12/319,060

(22) Filed: Dec. 31, 2008

(51) Int. Cl. G06F 9/46; G06F 1/26

(52) U.S. Cl. 713/300; 718/105

(57) ABSTRACT

A device, system, and method are disclosed. In one embodiment device includes remapping engine reallocation logic that is capable of monitoring a first amount of traffic that is translated by a first remapping engine. If the first amount of traffic reaches the threshold level of the first remapping engine, then the logic will divert a portion of the traffic to be translated by a second remapping engine.

### FIELD OF THE INVENTION

The invention relates to remapping engine translations in a computer platform implementing virtualization.

### BACKGROUND OF THE INVENTION

Many computer platforms use virtualization to more efficiently manage and prioritize resources. Input/Output (I/O) devices can benefit from virtualization as well. Intel® Corporation has come out with a Virtualization Technology for Direct I/O (VT-d) specification (Revision 1.0, September 2008) that describes the implementation details of utilizing direct memory access (DMA)-enabled I/O devices in a virtualized environment.

To efficiently translate virtual addresses to physical memory addresses in DMA requests and interrupt requests received from an I/O device, there has been logic developed that performs the translation called a remapping engine. A given computer platform may have several remapping engines. The VT-d specification allows a given I/O device, such as a Platform Component Interconnect (PCI) or PCI-Express device to be under the scope of a single remapping engine. This mapping of a device to a remapping engine is made at hardware design time and is a property of the design of the computer platform.

Mapping an I/O device to a single remapping engine makes it inflexible for a virtual machine monitor (VMM) or operating system (OS) and may result in degraded performance.

### BRIEF DESCRIPTION OF THE DRAWINGS

The present invention is illustrated by way of example and is not limited by the drawings, in which like references indicate similar elements, and in which:

FIG. 1 describes an embodiment of a system and device to reallocate remapping engines to balance the total remapping load between available remapping engines.

FIG. 2 is a flow diagram of an embodiment of a process to migrate an I/O device from one remapping engine to another remapping engine.

### DETAILED DESCRIPTION OF THE INVENTION

Embodiments of a device, system, and method to reallocate remapping engines to balance the total remapping load between available remapping engines are disclosed. In many scenarios, a primary remapping engine on a computer platform may become stressed due to a high amount of translations requested by a particular mapped I/O device (through DMA or interrupt requests). Logic within the computer platform may notice this stressful situation and find a secondary remapping engine that is not currently stressed. The logic may migrate the I/O device to the non-stressed secondary remapping engine to take the burden off of the primary remapping engine. Once migration is complete, all subsequent DMA and interrupt requests from the I/O device that require translation are translated by the secondary remapping engine.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

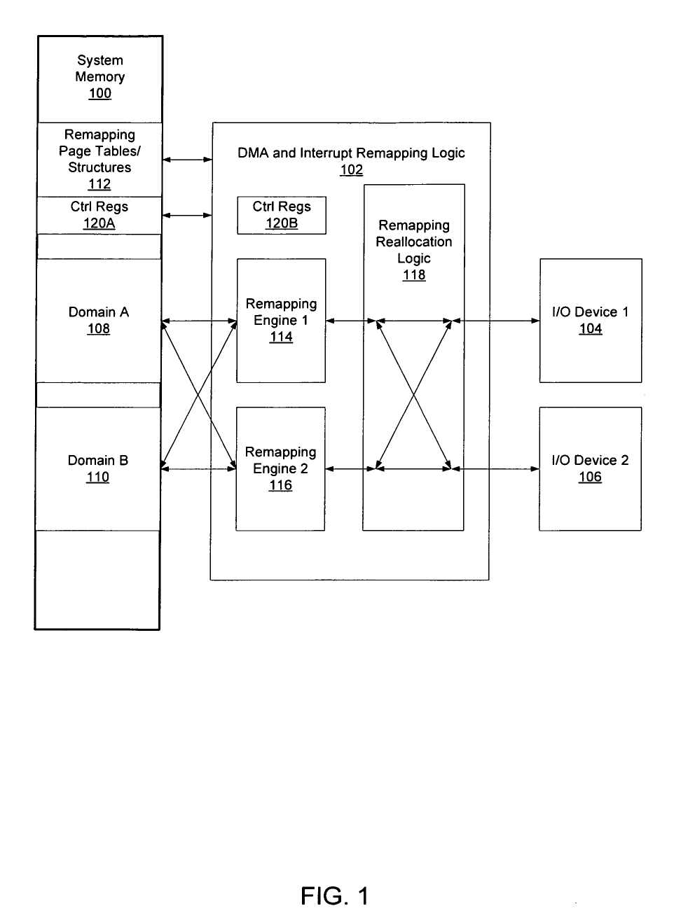

FIG. 1 describes an embodiment of a system and device to reallocate remapping engines to balance the total remapping load between available remapping engines. The remapping reallocation system may be a part of a computer platform (i.e. computer system) that includes one or more processors. The processors may each have one or more cores. The processors may be Intel®-brand microprocessors or another brand of microprocessors in different embodiments. The processors are not shown in FIG. 1.

The system includes a physical system memory 100. In some embodiments, the system memory 100 may be a type of dynamic random access memory (DRAM). For example, the system memory may be a type of double data rate (DDR) synchronous DRAM. In other embodiments, the system memory may be another type of memory such as a Flash memory.

The system includes direct memory access (DMA) and interrupt remapping logic 102. Virtualization remapping logic, such as DMA and interrupt remapping logic 102, protects physical regions of system memory 100 by restricting the DMA of input/output (I/O) devices, such as I/O device 1 (104) and I/O device 2 (106) to pre-assigned physical memory regions, such as domain A (108) for I/O device 1 (104) and domain B (110) for I/O device 2 (106). The remapping logic also restricts I/O device generated interrupts to these regions as well. The DMA and interrupt remapping logic 102 may be located in a processor in the system, in an I/O complex in the system, or elsewhere. An I/O complex may be an integrated circuit within the computer system that is discrete from the one or more processors. The I/O complex may include one or more I/O host controllers to facilitate the exchange of information between the processors/memory and one or more I/O devices in the system such as I/O device 1 (104) and I/O device 2 (106). While in certain embodiments the DMA and interrupt remapping logic 102 may be integrated into the I/O complex, the other portions of the I/O complex are not shown in FIG. 1. In some embodiments, such as in many system-on-a-chip embodiments, the I/O complex may be integrated into a processor, thus, if the DMA and interrupt remapping logic 102 is integrated into the I/O complex, it would also therefore be integrated into a processor in these embodiments.

The DMA and interrupt remapping logic 102 may be programmed by a virtual machine monitor (VMM) in some embodiments that allow a virtualized environment within the computer system. In other embodiments, the DMA and interrupt remapping logic 102 may be programmed by an operating system (OS).

In many embodiments, I/O device 1 (104) and I/O device 2 (106) are DMA-capable and interrupt-capable devices. In these embodiments, the DMA and interrupt remapping logic 102 translates the address of each incoming DMA request and interrupt from the I/O devices to the correct physical memory address in system memory 100. In many embodiments, the DMA and interrupt remapping logic 102 checks for permissions to access the translated physical address, based on the information provided by the VMM or the OS.

The DMA and interrupt remapping logic 102 enables the VMM or the OS to create multiple DMA protection domains, such as domain A (108) for I/O device 1 (104) and domain B (110) for I/O device 2 (106). Each protection domain is an isolated environment containing a subset of the host physical memory. The DMA and interrupt remapping logic 102 enables the VMM or the OS to assign one or more I/O devices to a protection domain. When any given I/O device tries to gain access to a certain memory location in system memory 100, DMA and interrupt remapping logic 102 looks up the remapping page tables 112 for access permission of that I/O device to that specific protection domain. If the I/O device tries to access outside of the range it is permitted to access, the DMA and interrupt remapping logic 102 blocks the access and reports a fault to the VMM or OS.

In many embodiments, there are two or more remapping engines, such as remapping engine 1 (114) and remapping engine 2 (116) integrated in the DMA and interrupt remapping logic 102. Each remapping engine includes logic to handle streams of DMA requests and interrupts from one or more I/O devices. The remapping engines generally start as being assigned to specific I/O devices. For example, remapping engine 1 (114) may be assigned to handle the DMA requests and interrupts to domain A (108) received from I/O device 1 (104) and remapping engine 2 (116) may be assigned to handle the DMA requests and interrupts to domain B (110) received from I/O device 2 (106).

Although the remapping engines originally may be assigned to translate DMA requests and interrupts to physical addresses for a specific I/O device, in many embodiments remapping reallocation logic 118 may modify these original assignments for each remapping engine dynamically due to observed workloads. In many embodiments, the DMA and interrupt remapping logic 102 and the remapping reallocation logic 118 are both utilized in a computer platform utilizing I/O Virtualization technologies. For example, I/O device 1 (104) may be generating a very heavy DMA request workload while I/O device 2 (106) is dormant. The heavy DMA request workload from I/O device 1 (104) may overload the capacity of remapping engine 1 (114), which would cause a degradation in the performance (i.e. response time) for the requests from I/O device 1 (104) as well as one or more additional I/O devices (not pictured) that also may be dependent upon remapping engine 1 (114). In this example, remapping reallocation logic 118 may notice the discrepancy in workloads and decide to split the DMA request workload received from I/O device 1 (104) equally between remapping engine 1 (114) and the otherwise unused remapping engine 2 (116). Thus, the added capacity of remapping engine 2 (116) would lighten the workload required with remapping engine 1 (114) and may increase performance of the responsiveness of requests for I/O device 1 (104).

In another example, the opposite may be true where remapping engine 2 (116) is overloaded with DMA requests received from I/O device 2 (106) and thus, remapping reallocation logic 118 can split off a portion of the received work to remapping engine 1 (114). In yet another example, a third I/O device (not pictured) initially assigned to remapping engine 1 (114) may be sending a great deal of interrupt traffic to remapping engine 1 (114) for translation. This interrupt traffic from I/O device 3 may be more traffic than the combination of DMA and interrupt requests from I/O devices 1 and 2 combined. In this example, remapping reallocation logic 118, may leave remapping engine 1 (114) to handle the incoming requests from I/O device 3, but may reallocate I/O device 1 (104) to remapping engine 2 (116). Thus, remapping engine 2 (116) may now need to translate the incoming requests for both I/O devices 1 and 2.

In many DMA and interrupt traffic scenarios, remapping reallocation logic 118 may attempt to reallocate DMA requests from one remapping engine to another to even out the workload received among all of the available remapping engines. In many embodiments not shown in FIG. 1, there may be a pool of remapping engines that includes more than two total remapping engines. In these embodiments, remapping reallocation logic 118 may reassign work among each of the remapping engines in the pool to fairly balance the total number of DMA requests among the entire pool. In some embodiments, if a single remapping engine, such as remapping engine 1 (114), is performing all the DMA request work, but the amount of work is small enough so as to not tax the particular remapping engine's capacity, the remapping reallocation logic 118 may not reallocate a portion of the DMA request workload. In some embodiments, reallocation is therefore performed generally when the workload for a given remapping engine has reached the remapping engine's threshold level of requests. Again, in many embodiments, the DMA and interrupt remapping logic 102 and the remapping reallocation logic 118 are both utilized in a computer platform utilizing I/O Virtualization technologies.

In many embodiments, the threshold level of requests is a number of requests over a given period of time that equal the limit that the remapping engine can handle without a degradation in performance. A degradation in remapping engine performance may be caused by a queue of DMA requests building up because the requests are received by the remapping engine at a faster rate than the remapping engine can translate requests. The remapping reallocation logic 118 may utilize one of a number of different methods to compare the current workload of DMA requests vs. the threshold level. For example, a ratio of requests over system clock cycles may be compared to a threshold ratio. The monitoring logic may be integrated into the remapping reallocation logic 118 since it receives all requests from the set of I/O devices and assigns each request to a remapping engine.

In many embodiments, the DMA remapping logic 102 provides one or more control registers for the VMM or OS to enable or disable the ability for remapping reallocation logic 118 to reallocate DMA request workloads between remapping engines. In many embodiments, remapping engines may be referred to as equivalent remapping engines if the same set of I/O devices are available to each one. Thus, one remapping engine theoretically could perform DMA request translations for a set of I/O devices while a second remapping engine is idle while the reverse is also true. If an I/O device is accessible to one remapping engine but not to another remapping engine, the remapping engines may not be considered equivalent. Equivalent remapping engines allow the remapping reallocation logic 118 to freely mix and match DMA request workloads with each equivalent remapping engine.

When equivalence between remapping engines is enabled by the VMM or OS through the one or more control registers, then each remapping engine may actively use the same set of remapping page tables 112 and any other remapping related registers to participate in the DMA request translation process. In many embodiments, the one or more control registers are software-based registers located in system memory, such as control registers 120A. In other embodiments, the one or more control registers are hardware-based registers physically located in the DMA remapping logic 102, such as control registers 120B.

In many embodiments, the DMA remapping logic 102 may communicate to the VMM or OS the equivalent relationship between two or more remapping engines using an extension to the current DRHD (DMA remapping Hardware unit definition) structure defined in the Intel® VT-d specification.

Each remapping engine has a DRHD structure in memory. For example, the DRHD structures may be located in the remapping page tables/structures 112 portion of system memory 100. In other embodiments, the DRHD structure may be in another location within system memory 100. The DRHD structure for each remapping engine includes an array of remapping engines which are equivalent to the remapping engine in question, this array is called the “equivalent DRHD array.” This array is a collection of fields and defined in Table 1. The array is used to communicate such equivalence to the VMM or OS. It is up to the VMM or OS to decide to use the alternative remapping engines to the remapping engine primarily assigned to a given I/O device when needed.

TABLE 1
The structural layout of an equivalent DRHD array.

| | |
|---|---|
| No of units in equivalent array | A 16-bit field indirectly indicating the |
| | length of this total field. |
| Base address of the first equivalent | This is a 64-bit field. Please see the |
| unit | Register Base address in the DRHD |
| | (Section 8.3 of the VT-d |
| | specification) |
| Base address of the nth equivalent | N is indicated in the first field |
| unit | |

In some embodiments, the remapping reallocation logic 118 may report the DMA request translation workload for each remapping engine to the VMM or OS, which would allow the VMM or OS to make the decision as to whether to enable and utilize alternative remapping engines to reduce the translation pressure on the primary remapping engine.

DMA remapping logic 102 may also communicate information about the capabilities of each remapping engine regarding migrating remapping page tables between remapping engines. Specifically, once the VMM or OS makes a determination to migrate the mapping entries for DMA and interrupt requests from one remapping engine to another, there can be a software-based or hardware-based page table copy.

In some embodiments, the VMM or OS can set up the page tables related to the newly reallocated I/O device and then copy the remapping page tables from the old remapping engine memory space of page tables to the new remapping engine memory space of page tables. In other embodiments, the DMA and interrupt remapping logic 102 can silently copy the page tables between remapping engine memory spaces. Copying these page tables silently allows the overhead to be removed from the VMM or OS software level and done at a lower hardware level. This may happen without the knowledge of software.

Once the page tables are copied (i.e. migrated) from the old remapping engine memory space to the new one, the new remapping engine is the remapping engine responsible for servicing all future translation requests from the I/O device in question. The old remapping engine is no longer responsible for the device I/O device and will no longer translate a DMA or interrupt request received from the device.

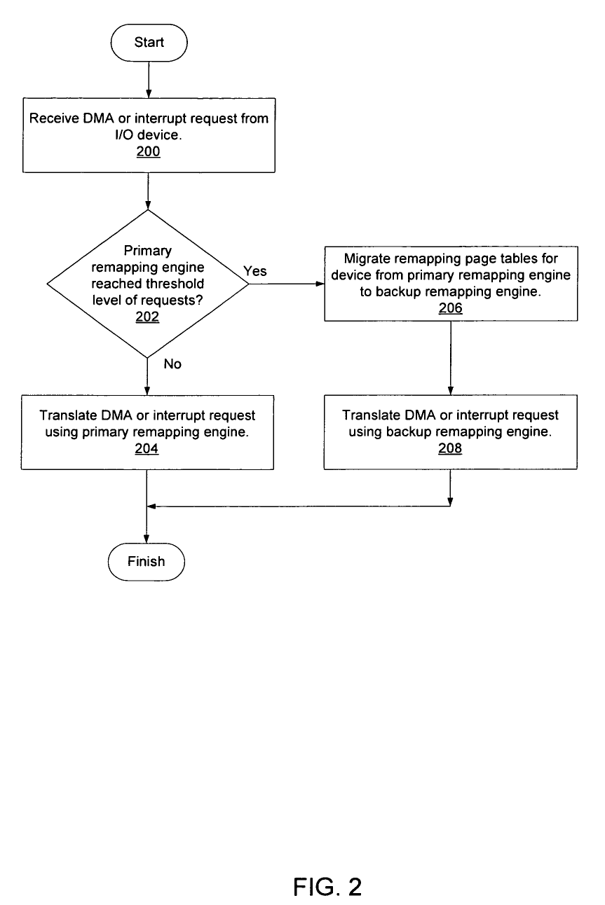

FIG. 2 is a flow diagram of an embodiment of a process to migrate an I/O device from one remapping engine to another remapping engine. The process is performed by processing logic which may be hardware, software, or a combination of both hardware and software. The process begins by processing logic receiving a DMA or interrupt request from an I/O device (processing block 200).

Processing logic determines whether the primary remapping engine assigned to service the request has reached its threshold level of requests over a certain period of time (processing block 202). This determination may utilize performance counters, time stamps, algorithms, and other methodologies to determine whether the primary remapping engine currently has enough translation requests to deteriorate the translation responsiveness of the engine per request.

For example, the VMM or OS can poll each remapping engine, either directly, or through the remapping allocation logic 1 18 to query the current state of remapping translation pressure on each remapping engine. In another example, the DMA and interrupt remapping logic 102 can interrupt the VMM or OS when at least one of the remapping engines begins to experience translation pressure or constraints on its translation resources. In both examples, the DMA and interrupt remapping logic 102 may also communicate more detailed information about the exact nature of the translation pressure including the hierarchy or the exact I/O devices that are the cause of the translation pressure. The VMM or OS may decide what performance information to use, if any, when determining whether to migrate an I/O device's translation entries to another equivalent remapping engine.

Returning to FIG. 2, if this threshold level of requests has not been reached, the processing logic has the primary remapping engine translate the DMA or interrupt request and the process is finished.

Otherwise, if the threshold level of requests has been reached, then processing logic determines which of one or more other equivalent remapping engines are available and are either currently being underutilized or not being used at all. This may include determining whether there is enough excess capacity in a given backup remapping engine to take the added pressure involved in the added device's traffic.

Once an available backup remapping engine is found, then processing logic migrates the remapping page tables for the I/O device from the primary remapping engine to the backup remapping engine (processing block 206). Once the backup remapping engine has received the I/O device's page tables that can be utilized for remapping, processing logic then diverts the DMA or interrupt request to the backup remapping engine (processing block 208) and the process is finished.

In many embodiments, once processing logic has verified that there is an equivalent remapping engine available, then processing logic can program a control register in hardware (FIG. 1, 120B) to indicate that the new backup remapping engine should be considered equivalent to the primary remapping engine.

In order to accommodate this register programming, current reserved fields in the Global command register (which is currently defined in the Intel® VT-d specification) can be redefined for this command (e.g. a command called Enable equivalent remapping engine). The new remapping engine may be identified through another 8-byte register for this purpose. Table 2 shows an example of the modifications made to the global command and status registers to implement for verifying equivalency between remapping engines.

TABLE 2
Global command and status register bits utilized for remapping
engine equivalency.

| | |
|---|---|
| Global command register bit 21 | If set to 1, a new equivalent remapping |
| | engine has been identified |
| | If set to 0, any existing equivalence |
| | relationship is removed |
| Global status register bit 21 | This bit is set to 1 after hardware is |
| | done with operation of the command |

The VMM or OS can enable equivalence either for all the current devices that are the scope of remapping engine A or only for a certain set of devices that are currently under the scope of remapping engine A. If the equivalence cannot be performed, the DMA and interrupt remapping logic 102 may communicate this error status through an error register.

Thus, embodiments of a device, system, and method to reallocate remapping engines to balance the total remapping load between available remapping engines are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A device, comprising:
remapping engine reallocation logic to
monitor a first amount of traffic being translated by a first remapping engine; and
divert a portion of the first amount of traffic to be translated by a second remapping engine when the first amount of traffic reaches a first remapping engine traffic threshold level.

2. The device of claim 1, wherein the remapping engine reallocation logic is further operable to:
prior to diverting the portion of the first amount of traffic, query the second remapping engine to determine an amount of translation capacity available; and
allow the diversion when the available amount of translation capacity is capable of servicing the portion of the first amount of traffic to be diverted.

3. The device of claim 2, wherein the remapping engine reallocation logic is further operable to:
determine the capacity of the first and second remapping engines; and
apportion a portion of the first amount of traffic to each of the first and 2nd remapping engines so that each engine has substantially the same percentage of traffic relative to each engine's maximum capacity.

4. The device of claim 3, wherein the remapping engine reallocation logic is further operable to:
divert a portion of the first amount of traffic to one or more additional remapping engines, wherein the first, second, and one or more additional remapping engines each have substantially the same percentage of traffic relative to each engine's maximum capacity.

5. The device of claim 1, wherein the first amount of traffic comprises traffic from at least a first device and a second device.

6. The device of claim 5, wherein the portion of the first amount of traffic diverted to the second remapping engine comprises at least the traffic from at least the second device.

7. The device of claim 1, wherein the remapping engine reallocation logic is further operable to:
monitor the first amount of traffic being translated by the first remapping engine and the second remapping engine; and
divert the portion of the first amount of traffic being translated by the second remapping engine to the first remapping engine when the first amount of traffic returns below the first traffic threshold level.

8. The device of claim 7, wherein the remapping engine reallocation logic is further operable to:
communicate to a power management logic that the second remapping engine can be shut down after the portion of the first amount of traffic being translated by the second remapping engine is diverted back to the first remapping engine.

9. A system, comprising:
a first device and a second device;
a first remapping engine and a second remapping engine, each remapping engine coupled to both the first and second devices; and
remapping engine reallocation logic, coupled to both the first and second remapping engines, the remapping engine reallocation logic to
monitor a first amount of traffic being translated by a first remapping engine; and
divert a portion of the first amount of traffic to be translated by a second remapping engine when the first amount of traffic reaches a first remapping engine traffic threshold level.

10. The system of claim 9, wherein the remapping engine reallocation logic is further operable to:
prior to diverting the portion of the first amount of traffic, query the second remapping engine to determine an amount of translation capacity available; and
allow the diversion when the available amount of translation capacity is capable of servicing the portion of the first amount of traffic to be diverted.

11. The system of claim 10, wherein the remapping engine reallocation logic is further operable to:
determine the capacity of the first and second remapping engines; and
apportion a portion of the first amount of traffic to each of the first and 2nd remapping engines so that each engine has substantially the same percentage of traffic relative to each engine's maximum capacity.

12. The system of claim 11, wherein the remapping engine reallocation logic is further operable to:
divert a portion of the first amount of traffic to one or more additional remapping engines, wherein the first, second, and one or more additional remapping engines each have substantially the same percentage of traffic relative to each engine's maximum capacity.

13. The system of claim 9, wherein the first amount of traffic comprises traffic from at least the first device and the second device.

14. The system of claim 13, wherein the portion of the first amount of traffic diverted to the second remapping engine comprises at least the traffic from at least the second device.

15. The system of claim 9, wherein the remapping engine reallocation logic is further operable to:
monitor the first amount of traffic being translated by the first remapping engine and the second remapping engine; and
divert the portion of the first amount of traffic being translated by the second remapping engine to the first remapping engine when the first amount of traffic returns below the first traffic threshold level.

16. The system of claim 15, further comprising:
a power management logic to manage the power delivered to at least each of the first and second remapping engines,
wherein the remapping engine reallocation logic is further operable to communicate to the power management logic to at least lower the amount of power delivered to the second remapping engine after the portion of the first amount of traffic being translated by the second remapping engine is diverted back to the first remapping engine.

17. A method, comprising:
monitoring a first amount of traffic being translated by a first remapping engine; and
diverting a portion of the first amount of traffic to be translated by a second remapping engine when the first amount of traffic reaches a first remapping engine traffic threshold level.

18. The method of claim 17, further comprising:
prior to diverting the portion of the first amount of traffic, querying the second remapping engine to determine an amount of translation capacity available; and
allowing the diversion when the available amount of translation capacity is capable of servicing the portion of the first amount of traffic to be diverted.

19. The device of claim 18, further comprising:
determining the capacity of the first and second remapping engines; and
apportioning a portion of the first amount of traffic to each of the first and 2nd remapping engines so that each engine has substantially the same percentage of traffic relative to each engine's maximum capacity.

20. The device of claim 19, further comprising:
diverting a portion of the first amount of traffic to one or more additional remapping engines, wherein the first, second, and one or more additional remapping engines each have substantially the same percentage of traffic relative to each engine's maximum capacity.

21. The device of claim 17, wherein the first amount of traffic comprises traffic from at least a first device and a second device.

22. The device of claim 21, wherein the portion of the first amount of traffic diverted to the second remapping engine comprises at least the traffic from at least the second device.

23. The device of claim 17, further comprising:
monitoring the first amount of traffic being translated by the first remapping engine and the second remapping engine; and
diverting the portion of the first amount of traffic being translated by the second remapping engine to the first remapping engine when the first amount of traffic returns below the first traffic threshold level.

24. The device of claim 23, further comprising:
communicating to a power management logic that the second remapping engine can be shut down after the portion of the first amount of traffic being translated by the second remapping engine is diverted back to the first remapping engine.
